(19) United States
(12) Patent Application Publication
(10) Pub. No.: US 2015/0294286 A1
(43) Pub. Date: Oct. 15, 2015

(54) Method for the capturing and payment of parking transactions

(71) Applicant: Scheidt & Bachmann GmbH, Monchengladbach (DE)

(72) Inventor: Karl Grote, Meerbusch (DE)

(21) Appl. No.: 14/683,178

(22) Filed: Apr. 10, 2015

(30) Foreign Application Priority Data
Apr. 10, 2014 (EP) 14 164 223.1

(51) Int. Cl. G06Q 20/14; G06Q 20/32; G06Q 50/30

(52) U.S. Cl. CPC G06Q 20/145; G06Q 50/30; G06Q 20/322

(57) ABSTRACT

In a method for capturing and paying parking transactions in parking facilities, a user, when entering the parking facility, reads out with a mobile terminal an entry identifier from an entry control device allocated to the parking facility entry, the mobile terminal stores the entry identifier in a memory or transmits the entry identifier together with an identifier of the mobile terminal to a background system, the user, when exiting the parking facility, reads out with the mobile terminal an exit identifier from an exit control device allocated to the parking facility exit, the mobile terminal transmits the entry and exit identifiers or transmits the exit identifier together with the identifier of the mobile terminal to the background system, the background system calculates the parking duration and fee exclusively based on data of the entry identifier and the exit identifier, and the parking fee is charged to the user.

### BACKGROUND OF THE INVENTION

The invention relates to a method for the capturing and payment of parking transactions in parking facilities.

Usually, non-registered parking transactions in parking facilities are captured and paid in that a user receives a short time park ticket from a park ticket issuing machine when entering the parking facility and enters the parking facility after an entry barrier has been opened or a light signal has permitted the entry. Before exiting the parking facility, the user inserts the short time park ticket into an automated pay station, where the ticket is read and the parking fee is determined. Thereupon, the user pays the parking fee and exits the parking facility via an exit within a predetermined period of time, typically within 15 minutes. The short time park tickets are typically paper tickets furnished with a magnetic strip or a bar code. Alternatively, also transponder coins can be used. An essential feature of a short time park ticket is that the user identity will not be registered.

Furthermore, so-called “long term parkers” can use the parking facility. Herein, the bank account and/or the invoice address of the respective long term parker are stored in a background system allocated to the car park operator. The long term parker usually receives his own user card which allows him access to the car park as long as he is registered as long term parker.

Various efforts have been made in the state of the art for simplifying the capturing and payment of parking transactions. The basic idea is to carry out capturing and payment transactions by means of a mobile terminal which the user carries along in most of the cases anyway.

In the state of the art, mobile terminals are used for purchasing and/or paying goods. This is for example realized by means of a so called QR code. Herein, using the service of a corresponding payment provider, a certain article shown on an advertising poster will be for example purchased and paid in that a QR code belonging to the respective article is scanned in by a mobile terminal of the user. The QR code comprises a hyperlink to a web portal of the seller. The user can confirm his purchase there and thus order the respective good against a price to pay. For paying the price, the user will be for example transferred to a web portal of a payment provider, where he can make a corresponding payment for the article. The payment can be for example made by using a virtual account, a credit card or a debit card, and usually the user's name and bank account or credit card details are registered with the payment provider. The payment provider then transmits a payment confirmation to the seller. After the payment transaction has been completed, the article will be dispatched. A corresponding method is for example described in the publication WO 2013/144930 A1.

US 2013/110727 A1 alternatively describes a method, in which a selling platform will contact a payment provider—after an article has been chosen by the user—and will receive a QR code allocated to the selected article by this provider. The user scans the QR code displayed on the web portal of the selling platform by means of his smart phone and transmits this QR code to the payment provider. Previously stored payment information of the user will be used for paying the article. The selling platform will then afterwards be informed by the payment provider about the payment that has been made.

In the state of the art, also methods for the capturing and payment of parking transactions by means of a smart phone are known. The publication US 2012/234906 A1 discloses a method, in which a user scans a static QR code placed on a parking meter by means of his smart phone. The scanned QR code will be afterwards used for paying the parking transactions by means of a web portal of a payment provider. According to a first embodiment, the user pays a parking fee calculated for a period of time that has been determined in advance. If it can be foreseen that this period of time will elapse, the user can advantageously receive a message on his mobile terminal, whereupon he can either pay for more parking time or he has to leave the parking zone after the maximum parking time has been reached. According to an alternative embodiment, the user registers at the parking meter without any advanced payment. The parking time elapsed will be paid after the parking has been ended. Herein, the user only pays the actually elapsed parking time.

Although the above mentioned system has proved to be successful for parking meters, it cannot be used for parking facilities, such as for example car parks. In contrast to the situation at a parking meter, it is not known in car parks which parking spot the user will occupy with his vehicle. It is furthermore not envisaged to install an expensive parking meter at each parking spot within the car park, which parking meter will be working during the respective parking time elapsed. Even abstracted systems would be required to be available at each single parking spot, which is not economic.

Although payment by means of payment providers via a mobile terminal are an established technology, these payments only work in case of sales transactions, in which the subject matter of the contract (transfer of ownership of the purchased goods/carrying out a service) and the valuable consideration (payment of the purchase price) have been defined and fixed. In such a transaction, the services to be exchanged are static. A parking transaction, on the contrary, is a “continuing” transaction, i.e. it has got the character of a rental contract, in which the service (transfer of the parking space for use) and the valuable consideration (payment of the fee according to the tariff) are only principally agreed upon when the lesser (car park owner) and the tenant (parking client) enter in the contracting relationship. Only when leaving the car park, the client determines the duration of the rent contract and thus the fee to be paid. A payment by means of payment providers via a mobile terminal is thus only possible for parking transactions, if a method is used which can determine the start and the end of the contracting relationship and substantiate the price on the base of the determined duration of the contracting relationship and make up a total invoice, such that the continuing transaction can be considered as a fixed purchase process by the payment provider.

It is thus the object of the present invention to create a method for the capturing and payment of parking transactions in parking facilities, which method is comfortable for the user and can be used at the same time for a plurality of parking vehicles within a parking facility (e.g. a car park) with as simple instrumentation as possible.

The method shall furthermore be adapted to integrate a cashless payment by means of a payment provider, which payment is made via a mobile terminal, such as for example a smart phone, into the chronological process of entry, payment and exit in a car park and to technically enable the determination of a fixed purchase price for the time-variable parking operation.

### SUMMARY OF THE INVENTION

For the technical solution, the invention proposes a method for the capturing and payment of parking transactions in parking facilities, the method comprising
a user, when entering the parking facility, reading out by means of a mobile terminal an entry identifier from an entry control device allocated to an entry of the parking facility,
the mobile terminal storing the entry identifier in a memory or transmitting the entry identifier together with an identifier of the mobile terminal to a background system,
the user, when exiting the parking facility, reading out by means of the mobile terminal an exit identifier from an exit control device allocated to an exit of the parking facility,
the mobile terminal transmitting the entry and exit identifiers or transmitting the exit identifier together with the identifier of the mobile terminal to the background system, and
the background system calculating the parking duration and parking fee exclusively by means of data of the entry identifier and the exit identifier.

Other advantages and features will be disclosed in the dependent claims.

The invention proposes a method for capturing and paying parking transactions in parking facilities, the method comprising: A user, when entering the parking facility, reads out by means of a mobile terminal an entry identifier from an entry control device allocated to an entry of the parking facility. The mobile terminal stores the entry identifier in a memory or transmitting the entry identifier together with an identifier of the mobile terminal to a background system. The user, when exiting the parking facility, reads out by means of the mobile terminal an exit identifier from an exit control device allocated to an exit of the parking facility. The mobile terminal transmits the entry and exit identifiers or transmitting the exit identifier together with the identifier of the mobile terminal to the background system, and the background system calculates the parking duration and parking fee exclusively by means of data of the entry identifier and the exit identifier.

The term “parking facility” in the sense of the invention designates all parking facilities for road vehicles for which the entries and exits are normally blocked and controlled by automatic park systems. Such parking facilities are for example car parks, parking lots, garages, underground garages or the like. A parking facility in this sense comprises at least one entry and at least one exit. The entry of the parking facility is regularly equipped with a locking device, which, under certain conditions, opens the entry into the parking facility. In a typical parking facility, this is an entry barrier including the barrier drive and a control system with a reading and/or issuing option for park tickets. The locking device can also be a roller shutter, a swing door, a retractable bollard or the like. Furthermore, there are parking facilities without barriers, the entries or exits of which are usually secured by means of cameras having a license plate recognition. Thanks to the license plate recognition, a vehicle which leaves the parking facility without having paid the fee can be detected and the parking fee can be invoiced from the user. Such parking facilities without barriers for example comprise a traffic light arrangement (red/green), by means of which the entry and/or exit will be blocked. In the sense of the invention, such parking facilities are equal with parking facilities having barriers.

According to the invention, an entry identifier respectively exit identifier will be provided by means of data technology at the entry control device and at the exit control device, such that the user, i.e. the driver of the vehicle to be parked, can read in the identifier by means of a mobile terminal. The data contained in the identifier are at least partially variable over time and contain the current date and the current time and an identifier of the parking facility that is unequivocal in the entire system and an identifier of an entry or an exit of the parking facility and/or a hyperlink to a web portal of the background system.

According to the invention, the user uses his mobile terminal, for example a smart phone, both at the entry and at the exit for reading in the entry identifier respectively the exit identifier. For determining the start of the parking transaction, the entry identifier will be transmitted by the mobile terminal to a background system. For example, the background system can be a system of the operator of the parking facility, but also background systems of external service providers can be used. The transmission between the mobile terminal and the background system can either include the complete transmission of the entry identifier or only the partial transmission of the entry identifier, i.e. only a part of the data content of the identifier. The entry identifier can comprise a data content composed of several data elements, wherein the mobile terminal can decompose the data content by means of a suitable application and then only transmit a part of the contained data to the background system.

According to a variant, the entry identifier will be stored in a memory of the mobile terminal. Upon leaving, the user will read in an exit identifier of an exit control device by means of his mobile terminal, which exit identifier will be transmitted together with the entry identifier stored in the memory of the mobile terminal to the background system.

Alternatively it is possible according to another variant that the entry identifier together with an identifier of the mobile terminal, for example a device number or telephone number, will be transmitted by the mobile terminal to the background system and stored in a memory of the background system, wherein upon exiting only the exit identifier together with the identifier of the mobile terminal will be transmitted by the mobile terminal to the background system.

Based on the data contained in the entry identifier and in exit identifier, the background system calculates the parking fee, once having received the exit identifier. Afterwards, the parking fee will be charged to the user, and the user can leave the parking facility with his vehicle.

Thanks to the evaluation of the data contained in the entry identifier and in the exit identifier, it will be possible to calculate the parking time and thus also the parking fee. It thus becomes possible to calculate the parking fee even for a parking duration which is unknown when the user enters the parking facility. Afterwards, the parking fee can be settled between the user and the operator of the parking facility by means of a payment provider. Such a payment provider can be for example PayPal. The mobile provider, in whose network the mobile terminal is operated, can also be used for settling the payment.

The payment of the parking fee by means of a payment provider has the advantage that a user can pay the parking in a cashless and anonymous manner, i.e. without disclosing his bank details to the operator of the car park.

The proposed method enables the mobile terminal of a user to function as a short term parking ticket and to determine and clear the parking fee in collaboration with the background system and the payment provider. The proposed method has the additional advantages that no physical ticket media are consumed and the user does not have to go to an automated pay station for paying the parking transaction.

The invention advantageously provides that the entry identifier and/or the exit identifier comprises a QR code or a bar code. Alternatively, it is however also possible to establish an NFC connection or a Bluetooth connection between the mobile terminal and the entry control device respectively the exit control device. In case of a QR code or bar code, standard code scanners on smart phones can be used. If a standard code scanner is used, the network connection between the mobile terminal and the background system can be established by means of known standard browsers. Those have in particular the advantage that the user does not have to install a specific application for a certain parking facility or a particular operator on his mobile terminal. However, the method can also be carried out by means of specific applications.

In a preferred embodiment it is envisaged that the entry identifier and/or the exit identifier, i.e. the data content thereof, will be generated in the entry control device respectively the exit control device and advantageously displayed on a display unit.

Herein, it is advantageously envisaged that the entry identifier and/or the exit identifier will be generated if the presence of a vehicle within the area of the respective control device is detected. To this end, a vehicle detection means for generating the identifier will be provided. Identifiers thus do not have to be generated repeatedly, but only when a vehicle is actually present in the entry or exit area.

The entry of the parking facility advantageously comprises an entry control device which is connected to a barrier drive via data connections, wherein the barrier drive pivots an entry barrier between a closed and an open position. The entry control device is connected to an induction loop or other detection means via a data connection. It is detected by means of this detection means, whether a vehicle is standing in front of the entry barrier or not. The detection means can be ultrasound sensors, light barriers or weight sensors. Furthermore, also other detection means are possible.

The entry control device is furthermore connected to a background system via a data connection and a network, which background system offers, inter alia, a web portal for a controlled user access via Internet and common browsers.

The entry control device advantageously comprises a display unit which can display both messages for the user and bar codes, wherein bar codes can be one-dimensional, two-dimensional or also three-dimensional. The two-dimensional bar codes, inter alia, comprise the QR codes. Three-dimensional codes comprise a color coding in addition to the two-dimensional coding. According to the invention, these bar codes are explicitly no static bar codes, such as for example pasted print bar codes, but bar codes which are currently generated at a specific moment and contain a variable data content, which bar codes are only valid for the user and the parking facility at the moment of detecting the presence of a vehicle. As an alternative to the use of bar codes or QR codes, the entry control device can also, if needed additionally, comprise means for the radio-based data transmission to a mobile terminal used by a user. These means can for example establish an NFC connection or a Bluetooth connection to the mobile terminal of the user, via which the same information content will be transmitted.

According to the invention, at the beginning of the parking transaction a vehicle standing in front of the entry barrier will be detected by the detection means arranged there. The entry control device thus determines the presence of the vehicle. Thereupon, the entry control device displays an entry identifier as bar code or QR code on its display unit or it transmits an entry identifier to a mobile terminal of the user in the above described manner. The user reads this entry identifier by means of his mobile terminal in a contactless manner. The entry identifier is preferably represented on a display unit of the entry control device. For the scanning, the user will use any standard bar code scanner application which is installed on his mobile terminal. Alternatively, also a specific application for the parking facility or the car park operator can be used.

Initiated by the scanning and the hyperlink contained in the entry identifier, a standard internet browser will be opened on the mobile terminal of the user, which internet browser will connect the mobile terminal via an internet connection to the background system. Based on the data content of the entry identifier, the background system can determine the local position of the mobile terminal (parking facility and the ID-number of the entry lane). These data can be displayed in the browser of the mobile terminal. Thereupon, the user can for example confirm that he wants to enter the parking facility. This is advantageously done in that he selects the action “open the barrier” in the browser. According to an alternative embodiment it is possible to automatically open the barrier without the user selecting this action. In the case of entries without barriers, which are for example secured by cameras, a red/green signal light controls the entry of a vehicle.

The data of the entry identifier can be stored as so called entity tag (e-tag according to http 1.1 protocol) in the mobile terminal. The e-tag comprising the data of the entry identifier is allocated to the browser of the mobile terminal and can thus also be retrieved in subsequent transactions. Known standard Internet browsers for mobile terminals can be used as browsers. In an alternative embodiment, the dialogue between the mobile terminal and the background system can however also be held via application specific to the parking facility or specific to the operator of the parking facility. The application does then not store the data of the entry identifier as e-tag, but as an application specific data set in a file or as a database entry in a memory of the mobile terminal.

In another embodiment, the data of the entry identifier will not be stored on the mobile terminal, but instead in a memory of the background system. In this case, also an unequivocal identifier of the mobile terminal has to be transmitted together with the data of the entry identifier to the background system and be stored there. Thereby, the data of the entry identifier can be correctly assigned to the same mobile terminal when exiting. The IMEI (International Mobile Station Equipment Identity) or alternatively also the telephone number or another key stored on the mobile terminal can be used as unequivocal identifier of the mobile terminal.

The entry will be completed in that the background system causes the entry control device, which belongs to the scanned entry identifier, via a data connection to open its entry barrier or to switch its signal light from red to green. The user can then enter the parking facility with his vehicle.

At the end of the parking transaction, the user drives his vehicle in the direction of the exit. As soon as the vehicle gets into the detection area of detection means placed in the area of the exit control device, it will be detected by the detection means, and the presence of the vehicle will be determined by the exit control device. Thereupon, the exit control device generates—analogously to the entry device—an exit identifier which is scanned by the user by means of his mobile terminal. In a variant, the exit identifier will be advantageously represented as QR code. Alternatively—in analogy to the entry—also radio connections, such as for example NFC connections or Bluetooth connections can be established. The exit identifier transmitted by the exit control device to the mobile terminal contains the exit date, the exit time, an unequivocal identification of the parking facility and the ID-number of the exit lane and/or a hyperlink to the web portal of the background system. Initiated by the scanning of the exit identifier by means of the mobile terminal or initiated by the hyperlink, which is contained in the exit identifier, an internet browser will be opened on the mobile terminal, which internet browser establishes an internet connection between the mobile terminal of the user and the background system.

Furthermore, the data of the entry identifier which have been stored as e-tag in the mobile terminal during the entry are retrieved from the mobile terminal of the user by the background system, in that they are read out of the memory of the mobile terminal by means of the browser and transmitted to the background system. In this moment the background system has available both the data of the entry identifier and the data of the exit identifier. Based on these data, the parking duration and thus the parking fee to be paid are calculated and transmitted as data by the background system to a payment provider. This data transmission takes advantageously place in that the internet connection of the browser of the mobile terminal is transferred via a URL redirect function from the background system to the server of the payment provider. Dependent on the load of the background system and the network load, it is possible that the transfer of the internet connection from the background system to the server of the payment provider is carried out so quickly that the internet page of the background system is not even displayed to the user anymore. The user has then the impression to be directly connected to the server of the payment provider, although from the purely technical point of view, at first a connection between the mobile terminal and the background system is established (for calculating the price) and just then the connection is re-directed to the payment provider, such that a connection between the mobile terminal and the server of the payment provider is established.

In another variant the connection between the mobile terminal and the background system is not established via a browser of the mobile terminal, but via an application specific to the parking facility or specific to the operator of the parking facility, which application transmits the data of the exit identifier and the data of the entry identifier, which have been previously stored upon entering the car park, to the background system.

Alternatively it is also possible to not store the data of the entry identifier on the mobile terminal, but—together with the unequivocal code of the mobile terminal—on a server of the background system. In this case, the mobile terminal only transmits the data of the exit identifier together with the identifier of the mobile terminal from the mobile terminal to the background system upon leaving the car park. On the base of the unequivocal identifier of the terminal and the unequivocal identifier of the parking facility contained in the entry and exit identifier, the background system determines the associated entry identifier, calculates the parking fee to be paid and transmits information about the parking fee via a data connection to the server of the payment provider.

After the calculation of the fee in the background system and the transmission to the payment provider, the server of the payment provider will hold information about the parking fee calculated by the background system. The data connection of the browser of the mobile terminal is also transferred via a URL redirect function to the server of the payment provider. The mobile terminal can then be used to confirm the payment transaction to the server of the payment provider. The confirmation process is dependent on the particular process of the respective payment provider. The user must for example confirm the payment by entering a pass word. But also other ways of confirming the payment are possible, such as for example a simple confirmation by pressing the “OK” key or the like. Upon confirmation of the payment, the server of the payment provider informs the background system about the confirmation of the payment via data dialogue.

The exit is completed in that after the confirmation of the payment, the background system causes the exit control device, which belongs to the scanned exit identifier, via a data connection to open its exit barrier or to switch its traffic light from “red” to “green”.

For reasons of data protection it can be envisaged to delete the e-tags or data sets used for determining the fee in the background system. The user himself can decide whether to delete or to keep the e-tags on the mobile terminal.

### BRIEF DESCRIPTION OF THE DRAWINGS

Subsequently, the invention will be explained in detail by means of an exemplary embodiment. FIGS. 1 through 4 show process steps with respect to entering into a parking facility. FIGS. 5 through 9 show process steps with respect to exiting from the parking facility.

The figures show in detail:

FIG. 1: system components in the area of the entry of the parking facility,

FIG. 2: the scanning of an entry identifier by means of a mobile terminal,

FIG. 3: the confirmation of the action “open barrier” by the mobile terminal to a background system,

FIG. 4: the opening of the entry barrier,

FIG. 5: system components in the area of the exit of the parking facility,

FIG. 6: the scanning of an exit identifier by means of the mobile terminal,

FIG. 7: the reading of the entry identifier and the exit identifier from the mobile terminal and transmission to the background system as well as price calculation,

FIG. 8: the payment of the calculated parking fee by means of the mobile terminal,

FIG. 9: the opening of the exit barrier after confirmation of the payment by a payment provider.

### DESCRIPTION OF PREFERRED EMBODIMENTS

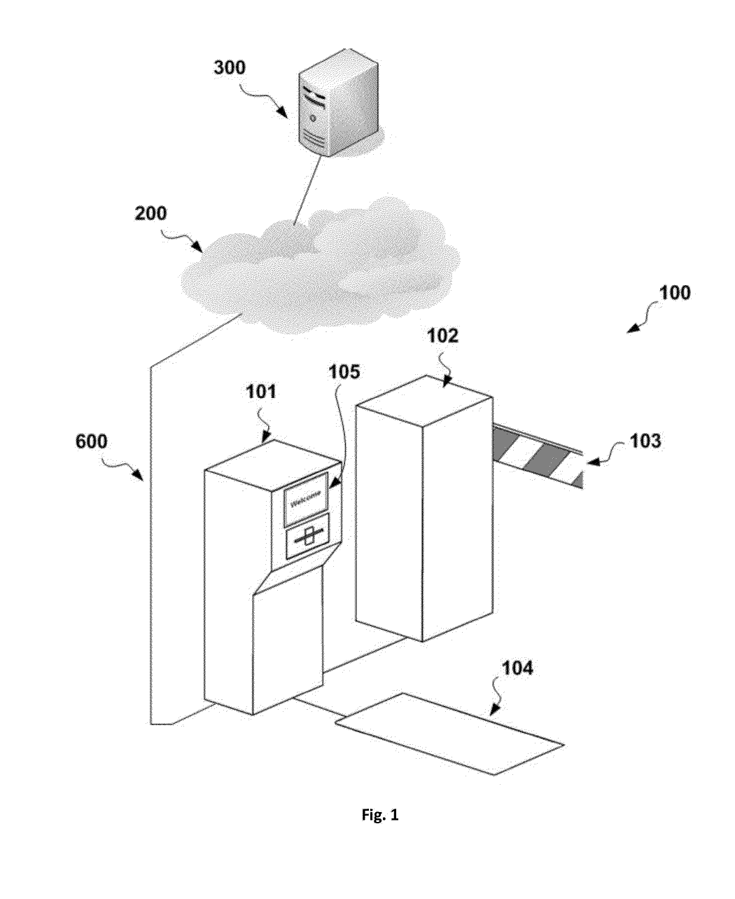

FIG. 1 shows an entry 100 of a parking facility. The entry 100 comprises a control device 101 which is connected to a barrier drive 102 via a data connection, which barrier drive pivots an entry barrier 103 between a closed and an open position. The control device 101 is connected, via a data connection, to an induction loop 104, by means of which the control device 101 detects whether a vehicle is standing in front of the entry barrier 103 or not. The control device 101 is furthermore connected to a background system 300 via a data connection 600 and a network 200. The control device 101 comprises a display unit 105 which can display both messages for the user and a OR code, a bar code or the like.

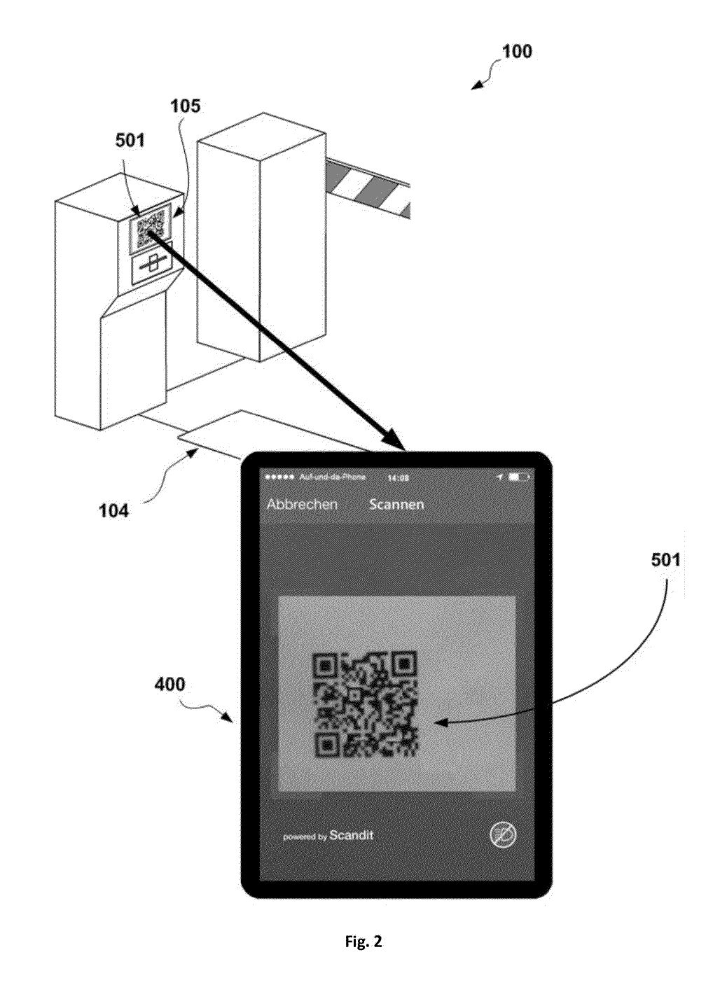

FIG. 2 shows the entry 100 in a situation, in which a vehicle (not shown) is standing in front of the entry barrier 103. The vehicle is detected by the induction loop 104 and the presence communicated to the entry control device 101. Thereupon, an entry identifier 501 appears on the display unit 105 of the entry control device 101. The user, i.e. the driver of the vehicle to be parked, contactlessly scans the entry identifier 501, i.e. here a OR code, by means of his mobile terminal (smart phone) 400. For this purpose, the user uses any suitable QR scanner application residing on his mobile terminal 400.

The entry identifier 501 is generated dynamically and displayed as soon as the induction loop 104 detects the presence of a vehicle. The entry identifier 501 contains the entrance date, the entrance time, a unequivocal identifier of the parking facility as well as a unequivocal identifier of the entry and a hyperlink to a web portal of the background system 300.

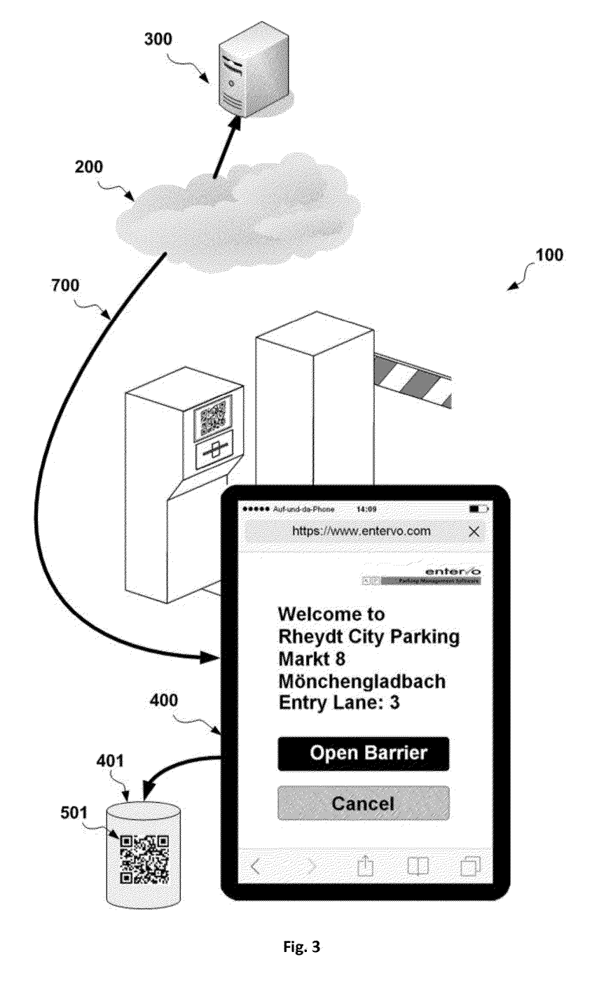

FIG. 3 shows the next step after the scanning of the entry identifier 501. Initiated by the scanning and the hyperlink in the entry identifier 501, an internet browser will be opened on the mobile terminal 400, which internet browser connects the mobile terminal 400 to the background system 300 via a mobile data connection 700. The background system 300 concludes the local position of the mobile terminal 400 (parking facility and ID-number of the entry 100) from the data of the entry identifier 501 and displays this one in the browser. The user confirms that he wants to enter the parking facility, in that he confirms the opening of the entry barrier 103 in the browser of his mobile terminal 400.

The data of the entry identifier 501 will be stored as so called entity-tag (e-tag) in a memory 401 of the mobile terminal 400. The e-tag (comprising the data of the entry identifier 501) is assigned to the browser of the mobile terminal 400 and can also be retrieved in the browser at a later time.

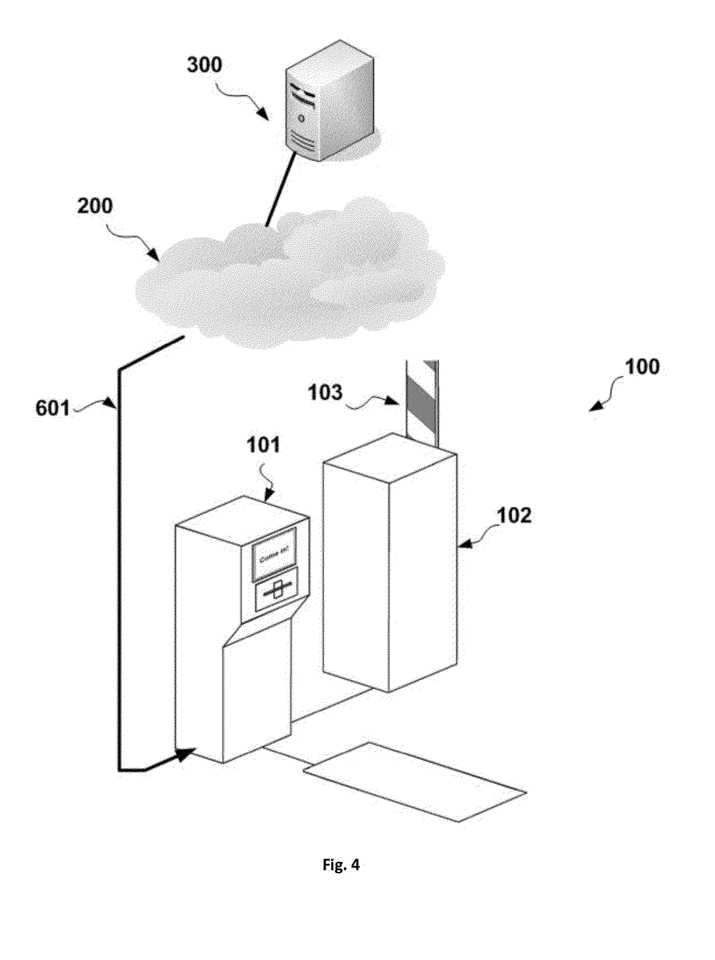

FIG. 4 shows the opening of the entry barrier 103 for the vehicle of the user. Via a data connection 601 and the entry control device 101, the background system 300 initiates the opening of exactly this entry barrier 103, the entry identifier 501 of which has been scanned before.

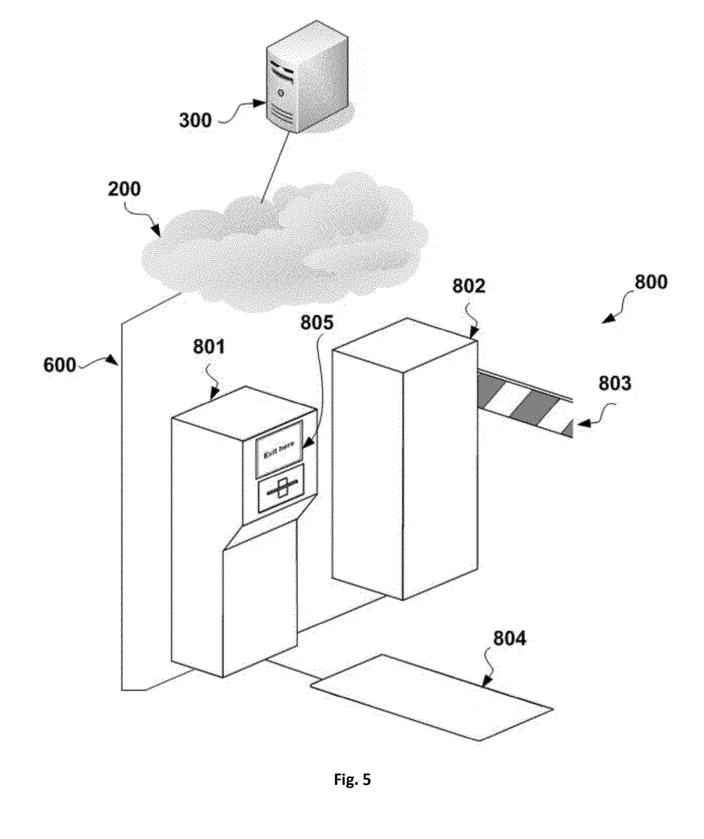

FIG. 5 shows the area of an exit 800 of the parking facility. The exit 800 comprises an exit control device 801 which is connected to a barrier drive 802 via a data connection. The barrier drive 802 pivots an exit barrier 803 between a dosed and an open position. The exit control device 801 is connected, via a data connection, to an induction loop 804, by means of which the exit control device 801 detects whether a vehicle is standing in front of the exit barrier 803 or not. The exit control device 801 is furthermore connected to a background system 300 via a data connection 600 and a network 200. The exit control device 801 furthermore comprises a display unit 805 which can display both messages for the user and exit identifiers 502.

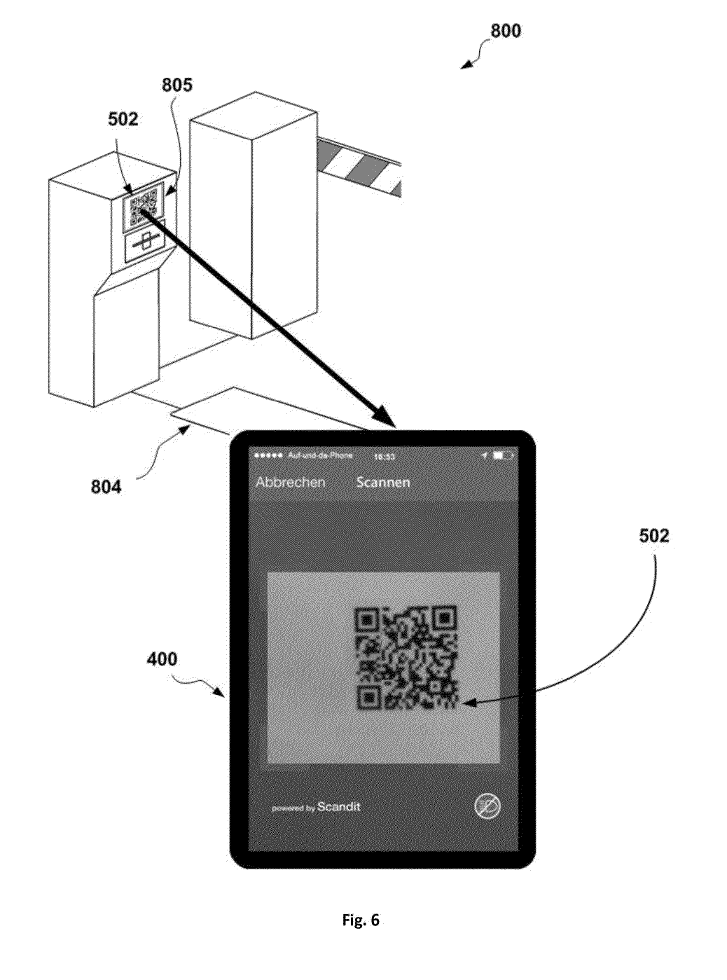

In FIG. 6 a situation is represented, in which a vehicle is standing in front of the exit barrier 803. In analogy with the procedure at the entry, the vehicle is detected by the induction loop 804. The presence of the vehicle is communicated to the exit control device 801. Thereupon, an exit identifier 502 (here a QR code) appears on the display unit 805 of the exit control device 801. The user contactlessly scans the exit identifier 502 by means of his mobile terminal 400. For this purpose, the user uses any QR scanner application which is installed on his mobile terminal 400.

The exit identifier 502 is generated dynamically and displayed as soon as the induction loop 804 detects the presence of a vehicle. The exit identifier 502 contains a variable data content which comprises the exit date, the exit time, an unequivocal identification of the parking facility and an unequivocal identification of the exit 800 as well as a hyperlink to the web portal of the background system 300.

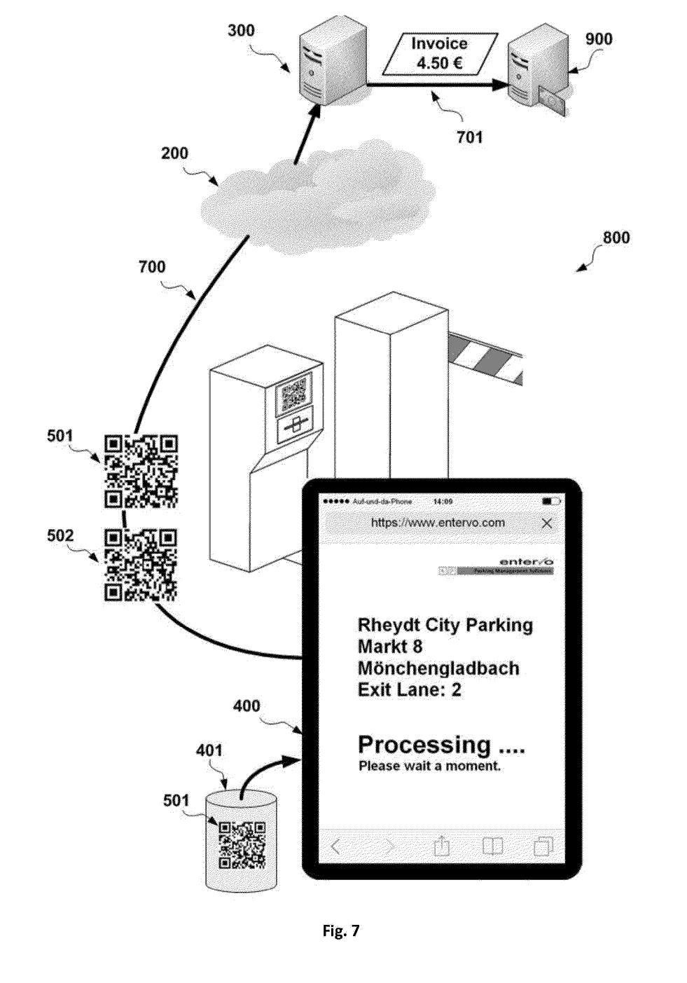

FIG. 7 shows the step following the scanning of the exit identifier 502. Initiated by the scanning and the hyperlink contained in the exit identifier 502, an internet browser will be opened on the mobile terminal 400, which internet browser connects the mobile terminal 400 to the background system 300 via a mobile data connection 700. Based on the data content of the exit identifier 502, the background system 300 recognizes the local position of the mobile terminal 400 (parking facility and number of the exit 800) and displays this one in the browser.

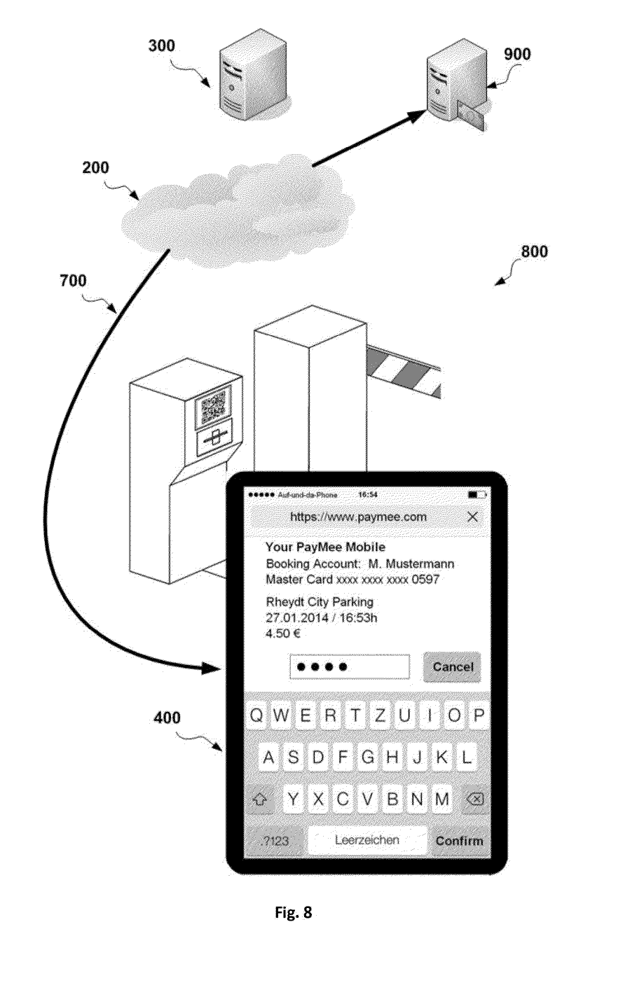

Furthermore, the data of the entry identifier 501, which have been stored as e-tag in the memory 401 of the mobile terminal 400 since the time of entering the parking facility, will be retrieved by the background system 300 and read from the memory 401 of the mobile terminal 400 by means of the browser and transmitted to the background system 300. The background system 300 has now available the data of the entry identifier 501 and the exit identifier 502, will calculate therefrom the parking fee for the parking transaction and will transmit the information about parking fee via a data connection 701 to the server of the payment provider 900. Herein, the internet connection of the browser installed on the mobile terminal 400 will be transferred via a URL redirect function. It is possible that the determination of the parking fee and the transmission of this information by the background system 300 are carried out so quickly that the user cannot see or only very shortly see the browser window shown in FIG. 7, and the user immediately sees the display shown in FIG. 8 on his mobile terminal 400. This display comprises a field for a confirmation of the payment.

FIG. 8 shows the subsequent step of payment. The information determined in the background system 300 in the previous step with respect to the parking fee has been transmitted to the server of the payment provider 900. The Internet connection of the browser of the mobile terminal 400 has also been redirected via a URL redirect function to the server of the payment provider 900. The mobile terminal 400 is now in a data connection 700 with the server of the payment provider 900 in order to confirm the payment transaction. The process of confirmation is dependent on the process of the respective payment provider 900. In FIG. 8 it is only exemplarily assumed that the user confirms the payment by entering a password. Alternatively, also other types of confirmation are possible, such as for example a simple confirmation by pressing an “OK” key.

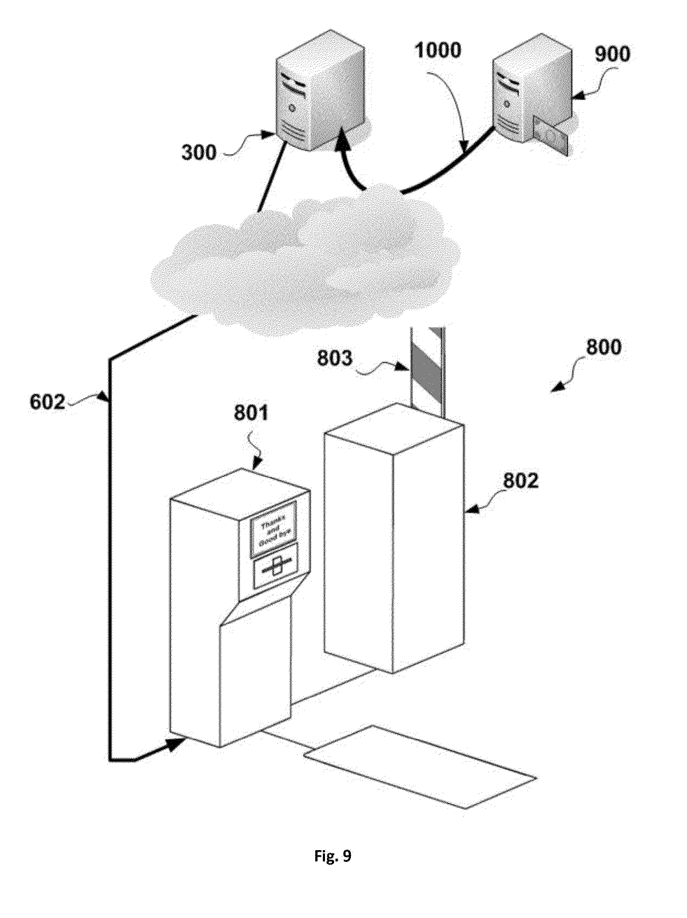

FIG. 9 shows the final step of leaving the parking facility. The server of the payment provider 900 confirms the payment to the background system 300 via a data connection 1000. The background system 300 then initiates via a data connection 602 that exactly this exit barrier 803, the exit identifier 502 of which has been previously scanned, will be opened for the user.

The specification incorporates by reference the entire disclosure of European priority document 14 164 223.1 having a filing date of 10 Apr. 2014.

While specific embodiments of the invention have been shown and described in detail to illustrate the inventive principles, it will be understood that the invention may be embodied otherwise without departing from such principles.

### LIST OF REFERENCE NUMERALS

100 entry

101 entry control device

102 barrier drive

103 entry barrier

104 induction loop

105 display unit

200 network

300 background system

400 mobile terminal

401 memory

501 entry identifier

502 exit identifier

600 data connection

601 data connection

602 data connection

700 data connection

701 data connection

800 exit

801 exit control device

802 barrier drive

803 exit barrier

804 induction loop

805 display unit

900 payment provider

1000 data connection

What is claimed is:

1. A method for the capturing and payment of parking transactions in parking facilities, the method comprising
a user, when entering the parking facility, reading out by means of a mobile terminal (400) an entry identifier (501) from an entry control device (101) allocated to an entry (100) of the parking facility,
the mobile terminal (400) storing the entry identifier (501) in a memory (401) or transmitting the entry identifier (501) together with an identifier of the mobile terminal (400) to a background system (300),
the user, when exiting the parking facility, reading out by means of the mobile terminal (400) an exit identifier (502) from an exit control device (801) allocated to an exit (800) of the parking facility,
the mobile terminal transmitting the entry and exit identifiers (501,502) or transmitting the exit identifier (502) together with the identifier of the mobile terminal (400) to the background system (300), and
the background system (300) calculating the parking duration and parking fee exclusively by means of data of the entry identifier (501) and the exit identifier (502).

2. The method according to claim 1, characterized in that the entry identifier (501) and the exit identifier (502) comprise a QR code or bar code.

3. The method according to claim 1, characterized in that the entry identifier (501) and/or exit identifier (502) comprises variable data content.

4. The method according to claim 1, characterized in that the entry identifier (501) and the exit identifier (502) comprise a date and a time and an identifier of the parking facility and an identifier of the entry or exit (100, 800) of the parking facility and a hyperlink to a web portal of the background system (300).

5. The method according to claim 1, characterized in that the entry identifier (501) and/or exit identifier (502) will be generated in the entry control device (101) respectively exit control device (801).

6. The method according to claim 5, characterized in that the entry identifier (501) and the exit identifier (502) are generated if a presence of a vehicle in the area of the entry control device (101) respectively exit control device (801) is detected.

7. The method according to claim 1, characterized in that the background system (300) transmits information about the calculated parking fee to a payment provider (900).

8. The method according to claim 7, characterized in that the user executes a payment of the parking fee on a web portal of the payment provider (900) by means of his mobile terminal (400).

9. The method according to claim 7, characterized in that the payment provider (900) transmits a payment confirmation (1000) to the background system (300).

10. The method according to claim 1, characterized in that messages to the user are displayed on a display unit (805) of the entry control device (101) respectively exit control device (801).

11. The method according to claim 1, characterized in that a data connection (700, 701) between the mobile terminal (400) and the background system (300) or between the mobile terminal (400) and a payment provider (900) is established by reading out a hyperlink contained in the entry identifier (501) respectively exit identifier (502).

12. The method according to claim 11, characterized in that the data connection (700, 701) is established by means of an internet browser or an application of the mobile terminal (400).
